(19) United States
(12) Patent Application Publication
(10) Pub. No.: US 2026/0358588 A1
(43) Pub. Date: Nov. 12, 2026

(54) BEND-RESISTANT OPTICAL FIBER AND MANUFACTURING PROCESS THEREOF

(71) Applicants: ZHONGTIAN TECHNOLOGY ADVANCED MATERIALS CO., LTD., Jiangsu (CN); Jiangsu Zhongtian Technology Co., Ltd., Jiangsu (CN); ZHONGTIAN TECHNOLOGY FIBRE OPTICS CO., LTD., Jiangsu (CN)

(72) Inventors: Liang HE, Jiangsu (CN); Yichun SHEN, Jiangsu (CN); Jianfeng ZHOU, Jiangsu (CN); Jingjing CHEN, Jiangsu (CN); Yali CHEN, Jiangsu (CN); Chunfeng WU, Jiangsu (CN)

(73) Assignees: ZHONGTIAN TECHNOLOGY ADVANCED MATERIALS CO., LTD., Jiangsu (CN); Jiangsu Zhongtian Technology Co., Ltd., Jiangsu (CN); ZHONGTIAN TECHNOLOGY FIBRE OPTICS CO., LTD., Jiangsu (CN)

(21) Appl. No.: 19/716,108

(22) Filed: Jun. 22, 2026

Related U.S. Application Data
(63) Continuation of application No. PCT/CN2026/088197, filed on Apr. 2, 2026.

(30) Foreign Application Priority Data
Feb. 26, 2025 (CN) 202510223034.5

(51) Int. Cl. G02B 6/44; C03B 37/014; G02B 6/028; G02B 6/036

(52) U.S. Cl. CPC G02B 6/4429; C03B 37/01446; G02B 6/0283; G02B 6/036; G02B 6/4479

(57) ABSTRACT

A bend-resistant optical fiber and a manufacturing process thereof, relating to the technical field of optical fibers, where the bend-resistant optical fiber includes a core layer, a first cladding layer wrapping the core layer, a gradient layer wrapping the first cladding layer, and a second cladding layer wrapping the gradient layer; and refractive indices of the core layer, the first cladding layer, the gradient layer and the second cladding layer decrease sequentially.

### CROSS-REFERENCE TO RELATED APPLICATIONS

This application is a continuation of the International Application No. PCT/CN2026/088197, filed on Apr. 2, 2026, which claims priority to the Chinese patent application No. 202510223034.5, filed with the China National Intellectual Property Administration on Feb. 26, 2025. The aforementioned applications are hereby incorporated by reference in their entireties.

### TECHNICAL FIELD

The present application relates to the technical field of optical fibers, in particular to a bend-resistant optical fiber and a manufacturing process thereof.

### BACKGROUND

An optical fiber is a fibrous material for transmitting optical signals, and transmits optical signals from one end to the other by utilizing a principle of total reflection of light.

In the related art, the optical fiber generally includes a core layer and a cladding layer wrapping the core layer. In some scenarios of communication network construction, the optical fiber needs to be bent and installed in a narrow space. At this time, bending of the optical fiber can easily cause partial optical signals to fail to complete total reflection transmission, thereby resulting in large bending losses, making it difficult to meet the requirements of network communications.

### SUMMARY

Embodiments of the present application provide a bend-resistant optical fiber and a manufacturing process thereof to solve the problem of large bending loss of optical fibers in the prior art.

In a first aspect, an embodiment of the present application provides a bend-resistant optical fiber, including:
a core layer;
a first cladding layer wrapping the core layer;
a gradient layer wrapping the first cladding layer;
a second cladding layer wrapping the gradient layer;
where refractive indices of the core layer, the first cladding layer, the gradient layer and the second cladding layer decrease sequentially.

In one possible implementation, a refractive index n1 of the core layer is 0.35-0.42%;
and/or, a refractive index n2 of the first cladding layer is −0.05% to 0;
and/or, a refractive index n3 of the second cladding layer is −0.4 to −0.2%;
and/or, a refractive index of the gradient layer exhibits a decreasing trend between n2 and n3.

In a second aspect, an embodiment of the present application provides a manufacturing process for a bend-resistant optical fiber, including the following steps:
sequentially depositing a core layer, a first cladding layer, a gradient layer and a second cladding layer to form a soot preform;
sintering the soot preform, and completing dehydration and fluorine doping such that refractive indices of the core layer, the first cladding layer, the gradient layer and the second cladding layer decrease sequentially.

In one possible implementation, sintering the soot preform and completing dehydration and fluorine doping includes:
feeding the soot preform into sintering equipment; when a temperature of the soot preform reaches 1000-1100 °C, introducing chlorine gas at 0.5-1.0 slpm and helium gas at 10-50 slpm to carry out dehydroxylation for moisture removal;
when the temperature of the soot preform reaches 1000-1300 °C, introducing fluoride at 0.3-2.0 slpm;
where a sintering speed of the soot preform is 6-15 mm/min.

In one possible implementation, feeding the soot preform into the sintering equipment includes:
placing the soot preform into the sintering equipment provided with a gas inlet hole and a gas outlet hole;
controlling the temperature of the soot preform via a heating body of the sintering equipment.

In one possible implementation, sequentially depositing the core layer, the first cladding layer, the gradient layer and the second cladding layer to form the soot preform includes: in a cavity of deposition equipment, separately and correspondingly depositing the core layer, the first cladding layer, the gradient layer and the second cladding layer by a core layer burner, a first cladding layer burner, a gradient layer burner and a second cladding layer burner respectively.

In one possible implementation, the core layer burner and the second cladding layer burner are burners with an annular multi-layer cylindrical structure.

In one possible implementation, the first cladding layer burner and the gradient layer burner are burners with a focusing structure.

In one possible implementation, after sintering the soot preform and completing dehydration and fluorine doping, it further includes:
performing vitrification on the sintered soot preform to form a glass rod;
performing an elongation treatment on the glass rod to form a core rod;
depositing an outer cladding layer on an outer side of the core rod, and sintering this entire assembly to obtain an optical fiber preform;
performing a drawing treatment on the optical fiber preform.

In one possible implementation, performing vitrification on the sintered soot preform includes:
when the temperature of the soot preform is 1300-1500 °C, introducing helium gas at 10-50 slpm to perform vitrification to form the glass rod.

A bend-resistant optical fiber and a manufacturing process thereof are provided by embodiments of the present application, where the bend-resistant optical fiber is provided with a core layer, a first cladding layer wrapping the core layer, a gradient layer wrapping the first cladding layer, a second cladding layer wrapping the gradient layer, and refractive indices of the core layer, the first cladding layer, the gradient layer and the second cladding layer decrease sequentially. In this way, by providing a distribution gradient of the refractive indices, a refractive index difference is formed between the core layer and each cladding layer, thereby enabling the optical fiber to better confine a propagation path of light when bent, reducing light leakage and loss caused by the optical fiber bending, effectively controlling bending loss, and solving the problem of large bending loss of optical fibers in the prior art; moreover, it also has the advantages of large mode field diameter, large effective area, and excellent bending performance.

### BRIEF DESCRIPTION OF DRAWINGS

The accompanying drawings herein, which are incorporated in and constitute a part of this description, illustrate embodiments consistent with the present application and together with the description serve to explain the principles of the present application.

FIG. 1 is a structural schematic diagram of a bend-resistant optical fiber provided by the present application;

FIG. 2 is a refractive index curve diagram of the bend-resistant optical fiber shown in FIG. 1;

FIG. 3 is a structural schematic diagram of deposition equipment in a manufacturing process of a bend-resistant optical fiber provided by the present application;

FIG. 4 is a structural schematic diagram of a core layer burner shown in FIG. 3;

FIG. 5 is a side sectional view of the core layer burner shown in FIG. 4;

FIG. 6 is a structural schematic diagram of a first cladding layer burner shown in FIG. 3;

FIG. 7 is a structural schematic diagram of sintering equipment in a manufacturing process of a bend-resistant optical fiber provided by the present application;

FIG. 8 is a refractive index curve diagram of Example 1 in a manufacturing process of a bend-resistant optical fiber provided by the present application;

FIG. 9 is a refractive index curve diagram of Example 2 in a manufacturing process of a bend-resistant optical fiber provided by the present application;

FIG. 10 is a refractive index curve diagram of Example 3 in a manufacturing process of a bend-resistant optical fiber provided by the present application;

FIG. 11 is a refractive index curve diagram of Comparative Example in a manufacturing process of a bend-resistant optical fiber provided by the present application.

### DESCRIPTION OF REFERENCE NUMERALS

10—soot preform;
20—seed rod;
100—core layer;
200—first cladding layer;
300—gradient layer;
400—second cladding layer;
500—deposition equipment; 510—cavity; 520—core layer burner; 530—first cladding layer burner; 540—gradient layer burner; 550—second cladding layer burner; 560—gas supply member; 570—gas exhaust member; 600—sintering equipment; 610—gas inlet hole; 620—gas outlet hole; 630—heating body.

Specific embodiments of the present application have been illustrated via the above accompanying drawings, and more detailed descriptions will be provided hereinafter. These drawings and text descriptions are not intended to limit the scope of the conception of the present application in any way, but rather to illustrate the concept of the present application to those skilled in the art with reference to specific embodiments.

### DESCRIPTION OF EMBODIMENTS

Exemplary embodiments will be described in detail herein, examples of which are illustrated in the accompanying drawings. When the following description refers to the accompanying drawings, same numerals in different drawings represent the same or similar elements unless otherwise indicated. The implementations described in the following exemplary embodiments do not represent all implementations consistent with the present application. Rather, they are merely examples of devices and methods consistent with certain aspects of the present application as detailed in the appended claims.

In the related art, an optical fiber generally includes a core layer and a cladding layer wrapping the core layer. In some scenarios of communication network construction, the optical fiber needs to be bent and installed in a narrow space.

When the optical fiber is bent, energy radiation along a bending radius direction always occurs, and some of guided modes in original optical waveguide will invariably become leaky modes, and even some will become radiation modes, thereby causing bending loss.

Therefore, the optical fiber bending can easily cause partial optical signals to fail to complete total reflection transmission, thereby resulting in large bending losses, making it difficult to meet the requirements of network communications.

In view of this, embodiments of the present application provide a bend-resistant optical fiber and a manufacturing process thereof. Where the bend-resistant optical fiber includes a core layer, a first cladding layer wrapping the core layer, a gradient layer wrapping the first cladding layer, and a second cladding layer wrapping the gradient layer; and refractive indices of the core layer, the first cladding layer, the gradient layer and the second cladding layer decrease sequentially. In this way, by providing a distribution gradient of the refractive indices, a refractive index difference is formed between the core layer and each cladding layer, thereby enabling the optical fiber to better confine a propagation path of light when bent, reducing light leakage and loss caused by the optical fiber bending, effectively controlling bending loss, and solving the problem of large bending loss of optical fibers in the prior art.

The technical solutions of the present application and how the technical solutions of the present application solve the above technical problems will be described in detail below with specific embodiments. The following several specific embodiments can be combined with each other, and the same or similar concepts or processes may not be repeated in some embodiments. Embodiments of the present application will be described below in conjunction with the accompanying drawings.

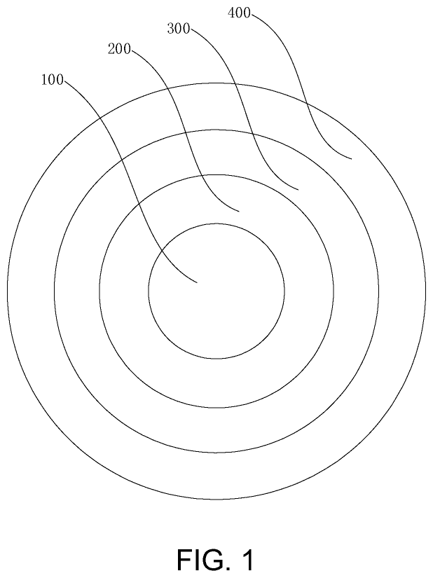

As shown in FIG. 1, a bend-resistant optical fiber provided by an embodiment of the present application includes:
a core layer 100;
a first cladding layer 200 wrapping the core layer 100;
a gradient layer 300 wrapping the first cladding layer 200;
a second cladding layer 400 wrapping the gradient layer 300;
refractive indices of the core layer 100, the first cladding layer 200, the gradient layer 300 and the second cladding layer 400 decrease sequentially.

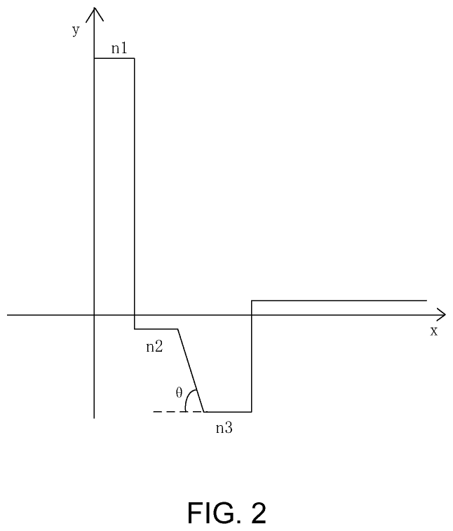

Specifically, as shown in FIG. 2, a refractive index n1 of the core layer 100 is 0.35-0.42%;
and/or a refractive index n2 of the first cladding layer 200 is −0.05% to 0;
and/or a refractive index n3 of the second cladding layer 400 is −0.4 to −0.2%;
and/or a refractive index of the gradient layer 300 exhibits a decreasing trend between n2 and n3.

It should be noted that a refractive index gradient between the gradient layer 300 and the first cladding layer 200 as well as the second cladding layer 400 forms an angle θ with respect to the x-axis, and θ ranges from 30°-90°. Exemplarily, θ may be 30°, 50°, 60°, 70°, 80°, 90° or other values, so that the first cladding layer 200, the gradient layer 300 and the second cladding layer 400 form a stepped recess structure from inside to outside.

In implementation, the refractive index n1 of the core layer 100 may be set to 0.35%, 0.38%, 0.40%, 0.41%, 0.42% or other values. The refractive index n2 of the first cladding layer 200 may be set to −0.05%, −0.04%, −0.03%, −0.02%, −0.01%, 0 or other values. The refractive index n3 of the second cladding layer 400 may be set to −0.4%, −0.35%, −0.30%, −0.25%, −0.2% or other values.

In this way, by providing a distribution gradient of the refractive indices, a refractive index difference is formed between the core layer 100 and each cladding layer, thereby enabling the optical fiber to better confine a propagation path of light when bent, reducing light leakage and loss caused by the optical fiber bending, effectively controlling bending loss, and solving the problem of large bending loss of optical fibers in the prior art; moreover, it also has the advantages of large mode field diameter, large effective area, and excellent bending performance.

In implementation, an outer cladding layer may be wrapped outside the second cladding layer 400 to ensure safety during use of the optical fiber.

It should be supplemented that research has found that the bending loss a of an optical fiber is related to structural parameters of the refractive index distribution of the optical fiber (such as relative refractive index Δ, fiber core radius a), namely:

α=k(a/Δ)²,
where k is a proportional constant related to the surface roughness and material properties of a contact surface of the optical fiber.

It can be seen from the formula that one method for reducing the bending loss is to increase the relative refractive index Δ or reduce the fiber core radius a to lower the bending loss of the optical fiber.

The method adopted in embodiments of the present application is embedding low-refractive-index glass into an inner cladding layer close to the fiber core or serving the low-refractive-index glass as a groove of the cladding layer to better confine light in the fiber core. This may effectively reduce the bending loss of the optical fiber.

In summary, in the bend-resistant optical fibers provided in the embodiments of the present application, by providing a distribution gradient of the refractive indices, a refractive index difference is formed between the core layer 100 and each cladding layer, thereby enabling the optical fiber to better confine a propagation path of light when bent, reducing light leakage and loss caused by the optical fiber bending, effectively controlling bending loss, and solving the problem of large bending loss of optical fibers in the prior art; moreover, it also has the advantages of large mode field diameter, large effective area, and excellent bending performance.

A manufacturing process for the bend-resistant optical fiber provided by an embodiment of the present application includes the following steps:
sequentially depositing a core layer 100, a first cladding layer 200, a gradient layer 300 and a second cladding layer 400 to form a soot preform 10;
sintering the soot preform 10, and completing dehydration and fluorine doping such that refractive indices of the core layer 100, the first cladding layer 200, the gradient layer 300 and the second cladding layer 400 decrease sequentially.

After sintering the soot preform 10 and completing dehydration and fluorine doping, it further includes:
performing vitrification on the sintered soot preform 10 to form a glass rod;
performing an elongation treatment on the glass rod to form a core rod;
depositing an outer cladding layer on an outer side of the core rod by an OVD process (Outer Vapor Deposition process), and sintering this entire assembly to obtain an optical fiber preform;
performing a drawing treatment on the optical fiber preform to obtain the bend-resistant optical fiber.

In this way, a refractive index difference is formed between the core layer 100 and each cladding layer, thereby enabling the optical fiber to better confine a propagation path of light when bent, reducing light leakage and loss caused by the optical fiber bending, effectively controlling bending loss, and solving the problem of large bending loss of optical fibers in the prior art.

In some embodiments, sequentially depositing the core layer 100, the first cladding layer 200, the gradient layer 300 and the second cladding layer 400 to form the soot preform 10 includes:
using a VAD process (Vapor Axial Deposition process), correspondingly depositing the core layer 100, the first cladding layer 200, the gradient layer 300 and the second cladding layer 400 in a cavity 510 of deposition equipment 500 by a core layer burner 520, a first cladding layer burner 530, a gradient layer burner 540 and a second cladding layer burner 550 respectively,

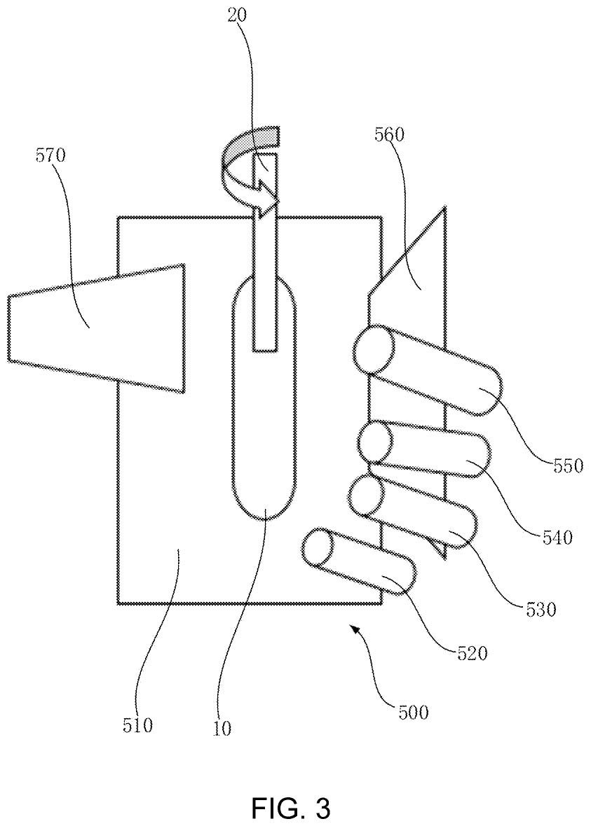

It should be noted that as shown in FIG. 3, the deposition equipment 500 includes a cavity 510, and a core layer burner 520, a first cladding layer burner 530, a gradient layer burner 540 and a second cladding layer burner 550, which are arranged on the cavity 510 and distributed sequentially from bottom to top. The deposition equipment 500 further includes a gas supply member 560 and a gas exhaust member 570. The gas supply member 560 and the gas exhaust member 570 are arranged on two sides of the cavity 510 respectively, and are used for supplying gas into the cavity 510 and discharging gas flow inside the cavity 510 respectively. Both the gas supply member 560 and the gas exhaust member 570 may be configured as fans.

In implementation, a carrier (the carrier may be a seed rod 20 or other rod pieces) extends into the cavity 510 from top and rotates and lifts upward at a set speed, and the carrier in this embodiment is the seed rod 20. Subsequently, the core layer burner 520 is controlled to first deposit the core layer 100 on an end of the seed rod 20 at a preset deposition gas flow rate; then according to a refractive index profile structure of each cladding layer, the first cladding layer burner 530 is controlled to deposit the first cladding layer 200 at a preset deposition gas flow rate, the gradient layer burner 540 is controlled to deposit the gradient layer 300 at a preset deposition gas flow rate, and the second cladding layer burner 550 is controlled to deposit the second cladding layer 400 at a preset deposition gas flow rate, in sequence from inside to outside. Thereby, the soot preform 10 in which refractive indices of the core layer 100, the first cladding layer 200, the gradient layer 300 and the second cladding layer 400 decrease sequentially is obtained, followed by subsequent processes.

Further, the core layer burner 520 and the second cladding layer burner 550 are burners with an annular multi-layer cylindrical structure; the first cladding layer burner 530 and the gradient layer burner 540 are burners with a focusing structure.

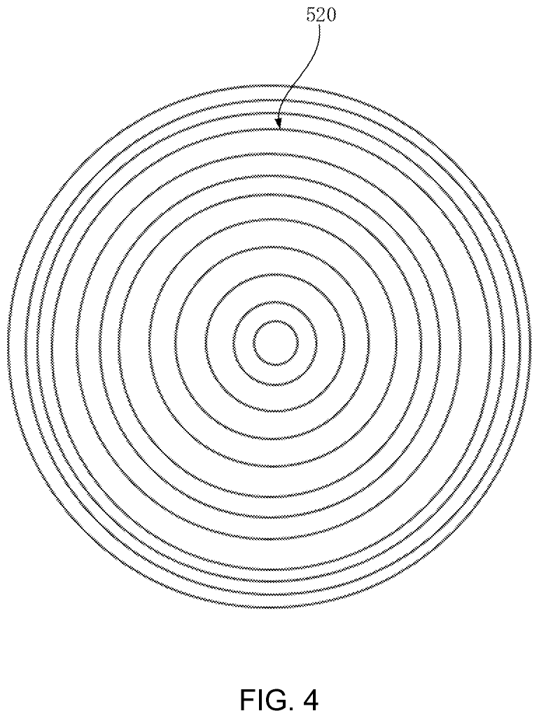

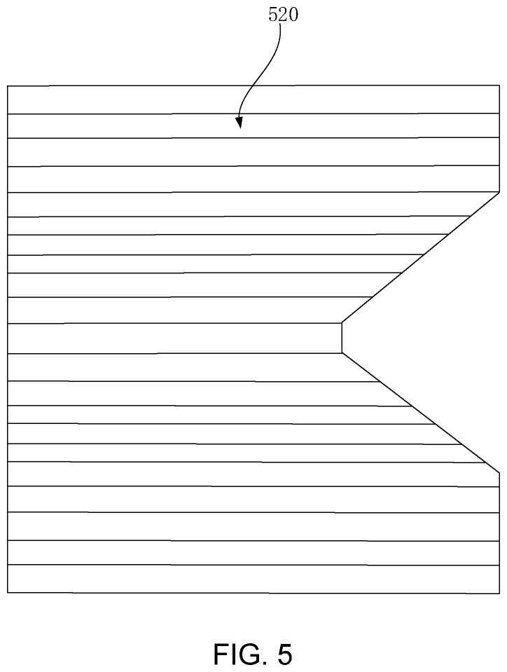

In this embodiment, as shown in FIG. 4 and FIG. 5, both the core layer burner 520 and the second cladding layer burner 550 are burners with an annular twelve-layer nozzle hole structure, which sequentially include a central nozzle hole, a first-layer annular nozzle hole, a second-layer annular nozzle hole, a third-layer annular nozzle hole, a fourth-layer annular nozzle hole, a fifth-layer annular nozzle hole, a sixth-layer annular nozzle hole, a seventh-layer annular nozzle hole, an eighth-layer annular nozzle hole, a ninth-layer annular nozzle hole, a tenth-layer annular nozzle hole and an eleventh-layer annular nozzle hole from inside to outside. Moreover, nozzle hole openings of the annular twelve-layer burner gradually protrude from a central tube where central nozzle hole is located to the seventh tube where seventh-layer annular nozzle hole is located in a stepped manner, so that low-density deposition control can be performed via this structure.

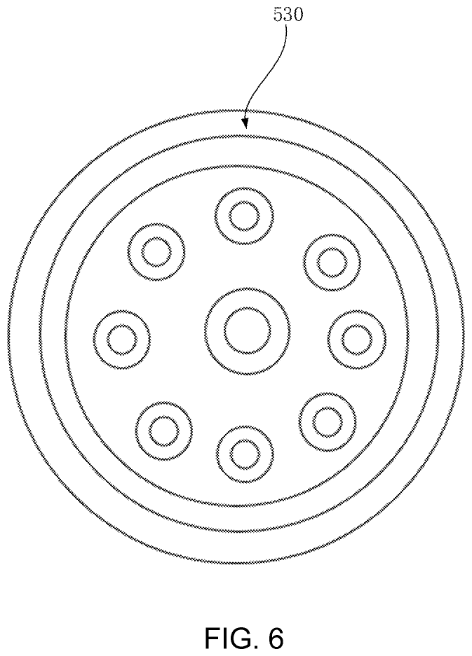

In this embodiment, as shown in FIG. 6, both the first cladding layer burner 530 and the gradient layer burner 540 are focusing six-fold burners, which sequentially include a central layer, a first layer, a second layer, a third layer for multi-hole focusing, a fourth layer and a fifth layer from inside to outside. Therefore, the focusing six-fold burner performs focused deposition at one point via an oxygen tube of the third layer, so as to realize high-density deposition control.

Specifically, a preset gas and a preset gas flow rate of each burner are as follows:
the core layer burner 520:
the central nozzle hole is supplied with SiCl₄ gas at a preset flow rate of 2-6 g/min and GeCl₄ gas at a preset flow rate of 0.3-0.5 slpm (standard liters per minute);
the first-layer annular nozzle hole is supplied with hydrogen gas at a preset flow rate of 4-10 slpm;
the second-layer annular nozzle hole is supplied with argon gas at a preset flow rate of 1-5 slpm;
the third-layer annular nozzle hole is supplied with oxygen gas at a preset flow rate of 10-30 slpm;
the fourth-layer annular nozzle hole is supplied with argon gas at a preset flow rate of 1-6 slpm;
the fifth-layer annular nozzle hole is supplied with hydrogen gas at a preset flow rate of 15-35 slpm;
the sixth-layer annular nozzle hole is supplied with argon gas at a preset flow rate of 1-6 slpm;
the seventh-layer annular nozzle hole is supplied with oxygen gas at a preset flow rate of 15-30 slpm;
the eighth-layer annular nozzle hole is supplied with argon gas at a preset flow rate of 1-6 slpm;
the ninth-layer annular nozzle hole is supplied with hydrogen gas at a preset flow rate of 15-35 slpm;
the tenth-layer annular nozzle hole is supplied with argon gas at a preset flow rate of 1-6 slpm;
the eleventh-layer annular nozzle hole is supplied with oxygen gas at a preset flow rate of 15-30 slpm.

The first cladding layer burner 530:
the central layer is supplied with SiCl₄ gas at a preset flow rate of 5-35 g/min and oxygen gas at 0-2 slpm;
the first layer is supplied with argon gas at a preset flow rate of 1-5 slpm;
the second layer is supplied with hydrogen gas at a preset flow rate of 60-100 slpm;
the third layer for multi-hole focusing is supplied with oxygen gas at a preset flow rate of 20-50 slpm;
the fourth layer is supplied with argon gas at a preset flow rate of 1-6 slpm;
the fifth layer is supplied with oxygen gas at a preset flow rate of 20-50 slpm;
a density of the first cladding layer 200 in the soot preform 10 is controlled in a range of 0.35-0.55 g/cm³.

The gradient layer burner 540:
the central layer is supplied with SiCl₄ gas at a preset flow rate of 1-20 g/min and oxygen gas at 2-10 slpm;
the first layer is supplied with argon gas at a preset flow rate of 1-5 slpm;
the second layer is supplied with hydrogen gas at a preset flow rate of 50-100 slpm;
the third layer for multi-hole focusing is supplied with oxygen gas at a preset flow rate of 20-50 slpm;
the fourth layer is supplied with argon gas at a preset flow rate of 1-6 slpm;
the fifth layer is supplied with oxygen gas at a preset flow rate of 10-40 slpm;
a density of the gradient layer 300 in the soot preform 10 is controlled in a range of 0.45-0.60 g/cm³.

The second cladding layer burner 550:
the central nozzle hole is supplied with SiCl₄ gas at a preset flow rate of 20-60 g/min;
the first-layer annular nozzle hole is supplied with hydrogen gas at a preset flow rate of 10-40 slpm;
the second-layer annular nozzle hole is supplied with argon gas at a preset flow rate of 1-5 slpm;
the third-layer annular nozzle hole is supplied with oxygen gas at a preset flow rate of 20-60 slpm;
the fourth-layer annular nozzle hole is supplied with argon gas at a preset flow rate of 1-6 slpm;
the fifth-layer annular nozzle hole is supplied with hydrogen gas at a preset flow rate of 40-100 slpm;
the sixth-layer annular nozzle hole is supplied with argon gas at a preset flow rate of 1-6 slpm;
the seventh-layer annular nozzle hole is supplied with oxygen gas at a preset flow rate of 25-60 slpm;
the eighth-layer annular nozzle hole is supplied with argon gas at a preset flow rate of 1-6 slpm;
the ninth-layer annular nozzle hole is supplied with hydrogen gas at a preset flow rate of 60-120 slpm;
the tenth-layer annular nozzle hole is supplied with argon gas at a preset flow rate of 1-6 slpm;
the eleventh-layer annular nozzle hole is supplied with oxygen gas at a preset flow rate of 50-120 slpm;
a density of the second cladding layer 400 in the soot preform 10 is controlled in a range of 0.22-0.3 g/cm³.

In addition, in actual implementation, a control system may be arranged on the deposition equipment 500. The control system may control lifting, lowering and rotation of the seed rod 20, and simultaneously the control system may control the preset deposition gas flow rates of the core layer burner 520, the first cladding layer burner 530, the gradient layer burner 540 and the second cladding layer burner 550, thereby ensuring stable and reliable deposition processes.

In some embodiments, sintering the soot preform 10 and completing dehydration and fluorine doping includes:
feeding the soot preform 10 into sintering equipment 600, and when a temperature of the soot preform 10 is 1000-1100 °C, introducing chlorine gas at 0.5-1.0 slpm and helium gas at 10-50 slpm to carry out dehydroxylation for moisture removal;
when the temperature of the soot preform 10 is 1000-1300 °C, introducing a fluoride at 0.3-2.0 slpm;
where a sintering speed of the soot preform 10 is 6-15 mm/min.

Subsequently, the soot preform 10 is vitrified to fabricate a glass rod in which refractive indices of the core layer 100, the first cladding layer 200, the gradient layer 300 and the second cladding layer 400 decrease sequentially. Finally a bend-resistant optical fiber is obtained through subsequent processes.

In some embodiments, feeding the soot preform 10 into the sintering equipment 600 includes:
placing the soot preform 10 into the sintering equipment 600 provided with a gas inlet hole 610 and a gas outlet hole 620;
controlling the temperature of the soot preform 10 via a heating body 630 of the sintering equipment 600.

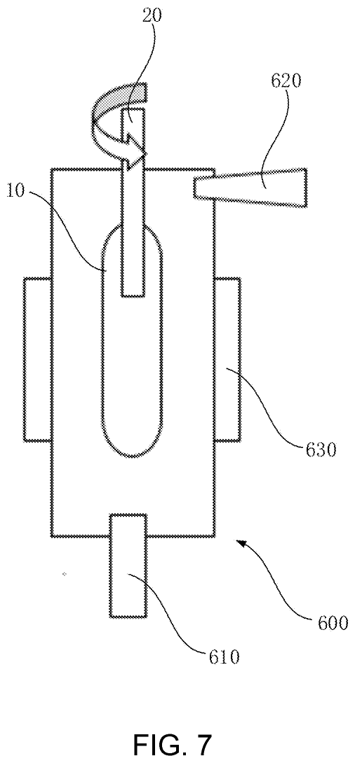

It should be noted that as shown in FIG. 7, the adopted sintering equipment 600 includes a hollow main body and a heating body 630 arranged on the main body for heating the soot preform 10; the main body is further provided with a gas inlet hole 610 and a gas outlet hole 620, both of which are communicated with an internal space of the main body, and the gas inlet hole 610 is located at the bottom of the main body, and the gas outlet hole 620 is located at the top of the main body. Where a material of the heating body 630 may be graphite, ceramic, resistance wire or other materials, and is not limited herein.

In implementation, the soot preform 10 is fed to the position of the heating body 630 inside the sintering equipment 600, then chlorine gas and helium gas are introduced from the gas inlet hole 610, and submerged the soot preform 10, and then are exhausted from the gas outlet hole 620. Meanwhile, the temperature required for sintering is controlled via the heating body 630 to achieve corresponding effects of dehydration and fluorine doping.

Next, performing vitrification on the sintered soot preform 10 includes:
in the sintering equipment 600, when the temperature of the soot preform 10 is 1300-1500 °C, introducing helium gas at 10-50 slpm to perform vitrification and form a glass rod, and then a glass rod in which refractive indices of the core layer 100, the first cladding layer 200, the gradient layer 300 and the second cladding layer 400 decrease sequentially is obtained. Finally, the glass rod is subjected to subsequent processes to produce the bend-resistant optical fiber.

In some embodiments, performing the drawing treatment on the optical fiber preform includes:
preforming tipping process to remove a tail handle portion of the optical fiber preform to obtain a remnant, performing a cross-sectional test on the remnant to obtain corresponding test parameters, and then reasonably controlling a drawing process according to the test parameters, so as to ensure a smooth progress of the drawing process.

In addition, the present disclosure will be described in detail through examples, and the present disclosure includes but is not limited to the following examples. A manufacturing process adopted by the following examples and comparative examples is as follows:
by a VAD process, sequentially depositing a core layer 100, a first cladding layer 200, a gradient layer 300 and a second cladding layer 400 via deposition equipment 500 to form a soot preform 10;
performing sintering on the soot preform 10, and performing dehydration and fluorine doping such that the refractive indices of the core layer 100, the first cladding layer 200, the gradient layer 300 and the second cladding layer 400 decrease sequentially;
performing vitrification on the soot preform 10 to form a glass rod.

After forming the glass rod, performing an elongation treatment on the glass rod to form a core rod;
depositing an outer cladding layer on an outer side of the core rod by an OVD process, and sintering this entire assembly to obtain an optical fiber preform;
preforming tipping process to remove a tail handle portion of the optical fiber preform to obtain a remnant, and performing a cross-sectional test on the remnant to obtain corresponding test parameters;
then performing a drawing treatment on the optical fiber preform according to the test parameters to obtain the bend-resistant optical fiber.

Where the deposition equipment 500 adopted in the examples is provided with a core layer burner 520, a first cladding layer burner 530, a gradient layer burner 540 and a second cladding layer burner 550. The deposition equipment 500 adopted in the comparative example is consistent with that adopted in the examples except that the gradient layer burner 540 is not provided.

Gas and a preset flow rate of each layer nozzle hole in each burner of each example and comparative example are as follows:

TABLE 1
Flow rate of core layer burner

| | Central Layer | First | Second | Third | Fourth | Fifth | Sixth | Seventh | Eighth | Ninth | Tenth | Eleventh |
|---|---|---|---|---|---|---|---|---|---|---|---|---|
| | SiCl₄(g/min)/ | Layer | Layer | Layer | Layer | Layer | Layer | Layer | Layer | Layer | Layer | Layer |
| | GeCl₄(slpm) | (slpm) | (slpm) | (slpm) | (slpm) | (slpm) | (slpm) | (slpm) | (slpm) | (slpm) | (slpm) | (slpm) |
| Comparative | 3/0.38 | 5.0 | 2.2 | 15 | 3.5 | 20 | 4.0 | 20 | 4 | 25 | 4 | 25 |
| Example | | | | | | | | | | | | |
| Example 1 | 3/0.30 | 5.0 | 2.2 | 15 | 3.5 | 20 | 4.0 | 20 | 4 | 25 | 4 | 25 |
| Example 2 | 3/0.32 | 5.0 | 2.2 | 15 | 3.5 | 20 | 4.0 | 20 | 4 | 25 | 4 | 25 |
| Example 3 | 3/0.35 | 5.0 | 2.2 | 15 | 3.5 | 20 | 4.0 | 20 | 4 | 25 | 4 | 25 |

TABLE 2
Flow rate of first cladding layer burner

| | Central Layer | First | Second | Third | Fourth | Fifth |
|---|---|---|---|---|---|---|
| | SiCl₄(g/min)/ | Layer | Layer | Layer | Layer | Layer |
| | Oxygen(slpm) | (slpm) | (slpm) | (slpm) | (slpm) | (slpm) |
| Comparative Example | 30/2.0 | 2 | 90 | 30 | 5 | 25 |
| Example 1 | 10/1.0 | 1.0 | 80 | 30 | 5 | 25 |
| Example 2 | 10/1.0 | 1.1 | 80 | 30 | 5 | 25 |
| Example 3 | 10/2.0 | 1.5 | 80 | 30 | 5 | 25 |

TABLE 3
Flow rate of gradient layer burner

| | Central Layer | First | Second | Third | Fourth | Fifth |
|---|---|---|---|---|---|---|
| | SiCl₄(g/min)/ | Layer | Layer | Layer | Layer | Layer |
| | Oxygen(slpm) | (slpm) | (slpm) | (slpm) | (slpm) | (slpm) |
| Example 1 | 5/6.0 | 2.3 | 70 | 25 | 5 | 20 |
| Example 2 | 10/7.0 | 2.3 | 75 | 25 | 5 | 20 |
| Example 3 | 10/8.0 | 2.3 | 80 | 25 | 5 | 20 |

TABLE 4
Flow rate of second cladding layer burner

| | | First | Second | Third | Fourth | Fifth | Sixth | Seventh | Eighth | Ninth | Tenth | Eleventh |
|---|---|---|---|---|---|---|---|---|---|---|---|---|
| | Central Layer | Layer | Layer | Layer | Layer | Layer | Layer | Layer | Layer | Layer | Layer | Layer |
| | SiCl₄(g/min) | (slpm) | (slpm) | (slpm) | (slpm) | (slpm) | (slpm) | (slpm) | (slpm) | (slpm) | (slpm) | (slpm) |
| Comparative | 35 | 8.0 | 3.5 | 20 | 5 | 60 | 5 | 30 | 6 | 86 | 6 | 50 |
| Example | | | | | | | | | | | | |
| Example 1 | 35 | 8.0 | 3.5 | 20 | 5 | 60 | 5 | 30 | 6 | 86 | 6 | 50 |
| Example 2 | 35 | 8.0 | 3.5 | 20 | 5 | 60 | 5 | 30 | 6 | 86 | 6 | 50 |
| Example 3 | 35 | 8.0 | 3.5 | 20 | 5 | 60 | 5 | 30 | 6 | 86 | 6 | 50 |

### Example 1

As shown in Tables 1-4, the flow rates of the core layer burner 520 are set as follows:
the central nozzle hole is supplied with SiCl₄ gas at a preset flow rate of 3 g/min and GeCl₄ gas at a preset flow rate of 0.30 slpm;
the first annular nozzle hole is supplied with hydrogen gas at a preset flow rate of 5 slpm;
the second annular nozzle hole is supplied with argon gas at a preset flow rate of 2.2 slpm;
the third annular nozzle hole is supplied with oxygen gas at a preset flow rate of 15 slpm;
the fourth annular nozzle hole is supplied with argon gas at a preset flow rate of 3.5 slpm;
the fifth annular nozzle hole is supplied with hydrogen gas at a preset flow rate of 20 slpm;
the sixth annular nozzle hole is supplied with argon gas at a preset flow rate of 4.0 slpm;
the seventh annular nozzle hole is supplied with oxygen gas at a preset flow rate of 20 slpm.
The flow rates of the first cladding layer burner 530 are set as follows:
the central layer is supplied with SiCl₄ gas at a preset flow rate of 10 g/min and oxygen gas at 1.0 slpm;
the first layer is supplied with argon gas at a preset flow rate of 1.0 slpm;
the second layer is supplied with hydrogen gas at a preset flow rate of 80 slpm;
the third layer for multi-hole focusing is supplied with oxygen gas at a preset flow rate of 30 slpm;
the fourth layer is supplied with argon gas at a preset flow rate of 5 slpm;
the fifth layer is supplied with oxygen gas at a preset flow rate of 25 slpm.

The flow rates of the gradient layer burner 540 are set as follows:
the central layer is supplied with SiCl₄ gas at a preset flow rate of 5 g/min and oxygen gas at 6 slpm;
the first layer is supplied with argon gas at a preset flow rate of 2.3 slpm;
the second layer is supplied with hydrogen gas at a preset flow rate of 70 slpm;
the third layer for multi-hole focusing is supplied with oxygen gas at a preset flow rate of 25 slpm;
the fourth layer is supplied with argon gas at a preset flow rate of 5 slpm;
the fifth layer is supplied with oxygen gas at a preset flow rate of 20 slpm.

The flow rates of the second cladding layer burner 550 are set as follows:
the central nozzle hole is supplied with SiCl₄ gas at a preset flow rate of 35 g/min; the first annular nozzle hole is supplied with hydrogen gas at a preset flow rate of 8 slpm;
the second annular nozzle hole is supplied with argon gas at a preset flow rate of 3.5 slpm;
the third annular nozzle hole is supplied with oxygen gas at a preset flow rate of 20 slpm;
the fourth annular nozzle hole is supplied with argon gas at a preset flow rate of 5 slpm;
the fifth annular nozzle hole is supplied with hydrogen gas at a preset flow rate of 60 slpm;
the sixth annular nozzle hole is supplied with argon gas at a preset flow rate of 5 slpm;
the seventh annular nozzle hole is supplied with oxygen gas at a preset flow rate of 30 slpm.

### Example 2

As shown in Tables 1-4, the flow rates of the core layer burner 520 are set as follows:
the central nozzle hole is supplied with SiCl₄ gas at a preset flow rate of 3 g/min and GeCl₄ gas at a preset flow rate of 0.32 slpm; the preset flow rates of other nozzle holes are the same as those in Example 1.

The flow rates of the first cladding layer burner 530 are set as follows:
the first layer is supplied with argon gas at a preset flow rate of 1.1 slpm; the preset flow rates of other layers are the same as those in Example 1.

The flow rates of the gradient layer burner 540 are set as follows:
the central layer is supplied with SiCl₄ gas at a preset flow rate of 10 g/min and oxygen gas at 7 slpm; the second layer is supplied with hydrogen gas at a preset flow rate of 75 slpm; the preset flow rates of other layers are the same as those in Example 1.

The flow rates of the second cladding layer burner 550 are set as follows:
the preset flow rates of all nozzle holes are the same as those in Example 1.

### Example 3

As shown in Tables 1-4, the flow rates of the core layer burner 520 are set as follows:
the central nozzle hole is supplied with SiCl₄ gas at a preset flow rate of 3 g/min and GeCl₄ gas at a preset flow rate of 0.35 slpm; the preset flow rates of other nozzle holes are the same as those in Example 1.

The flow rates of the first cladding layer burner 530 are set as follows:
the central layer is supplied with SiCl₄ gas at a preset flow rate of 10 g/min and oxygen gas at 2.0 slpm; the first layer is supplied with argon gas at a preset flow rate of 1.5 slpm; the preset flow rates of other layers are the same as those in Example 1.

The flow rates of the gradient layer burner 540 are set as follows:
the central layer is supplied with SiCl₄ gas at a preset flow rate of 10 g/min and oxygen gas at 8 slpm; the second layer is supplied with hydrogen gas at a preset flow rate of 80 slpm; the preset flow rates of other layers are the same as those in Example 1.

The flow rates of the second cladding layer burner 550 are set as follows:
the preset flow rates of all nozzle holes are the same as those in Example 1.

### Comparative Example

As shown in Tables 1-4, the flow rates of the core layer burner 520 are set as follows:
the central nozzle hole is supplied with SiCl₄ gas at a preset flow rate of 3 g/min and GeCl₄ gas at a preset flow rate of 0.38 slpm; the preset flow rates of other nozzle holes are the same as those in Example 1.

The flow rates of the first cladding layer burner 530 are set as follows:
the central layer is supplied with SiCl₄ gas at a preset flow rate of 30 g/min and oxygen gas at 2 slpm; the first layer is supplied with argon gas at a preset flow rate of 2 slpm; the second layer is supplied with hydrogen gas at a preset flow rate of 90 slpm; the preset flow rates of other layers are the same as those in Example 1.

No gradient layer burner 540 is provided.

The flow rates of the second cladding layer burner 550 are set as follows:
the preset flow rates of all nozzle holes are the same as those in Example 1.

As shown in Table 5, with regard to parameters for sintering and dehydration, the temperature, chlorine gas flow rate and helium gas flow rate are identical in each example and comparative example.

TABLE 5
Parameters for sintering and dehydration

| | | Chlorine gas (Standard | |
|---|---|---|---|
| | Temperature | Cubic Centimeters per | Helium gas |
| | (°C) | Minute, sccm) | (slpm) |
| Comparative | 1040 | 1000 | 20 |
| Example | | | |
| Example 1 | 1040 | 1000 | 20 |
| Example 2 | 1040 | 1000 | 20 |
| Example 3 | 1040 | 1000 | 20 |

As shown in Table 6, with regard to the parameters for sintering and fluorine doping, the preset temperature of each embodiment is 1250 °C, while the preset temperature of the comparative example is 1040 °C; the fluorine flow rate, helium gas flow rate, moving speed and other parameters are identical in each example and comparative example.

As shown in Table 7, with regard to the parameters for vitrification: the temperature and helium gas flow rate are identical in each example and comparative example.

TABLE 6
Parameters for sintering and fluorine doping

| | Moving speed | Temperature | Fluoride | Helium gas |
|---|---|---|---|---|
| | (mm/min) | (°C) | (sccm) | (slpm) |
| Comparative | 10 | 1040 | 400 | 10 |
| Example | | | | |
| Example 1 | 10 | 1250 | 400 | 10 |
| Example 2 | 10 | 1250 | 400 | 10 |
| Example 3 | 10 | 1250 | 400 | 10 |

TABLE 7
Parameters for vitrification

| | Temperature (°C) | Helium gas (slpm) |
|---|---|---|
| Comparative Example | 1350 | 20 |
| Example 1 | 1350 | 20 |
| Example 2 | 1350 | 20 |
| Example 3 | 1350 | 20 |

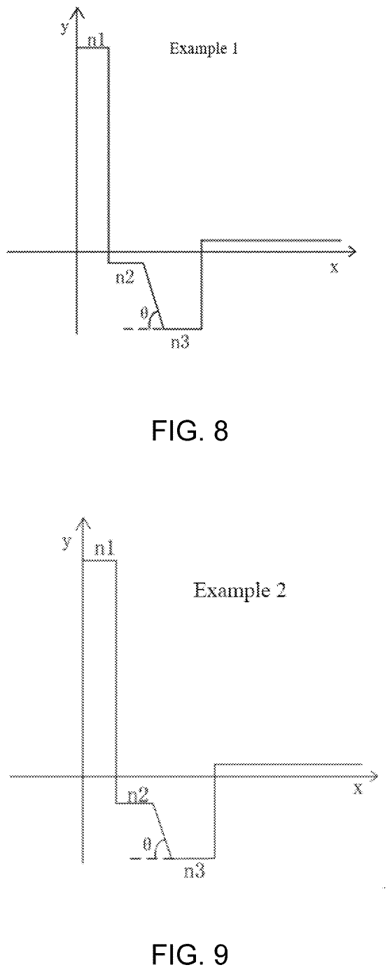

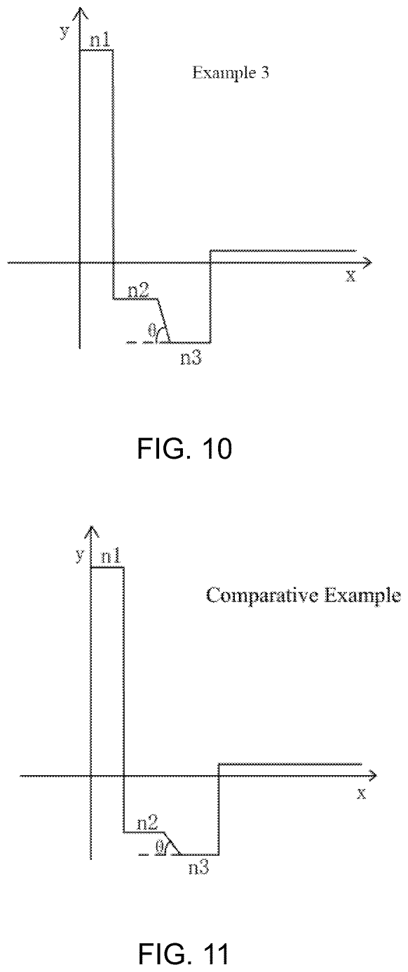

Finally, cross-sectional test is performed on the remnants of the optical fiber preforms prepared in each example and comparative example to obtain corresponding test parameters as shown in Table 8 and FIG. 3, and the parameters of the optical fiber produced are shown in Table 9 and FIGS. 8-11.

TABLE 8
Cross-sectional parameters

| | n1 | n2 | n3 | Angle θ (°) |
|---|---|---|---|---|
| Comparative | 0.360 | −0.15 | −0.25 | 20 |
| Example | | | | |
| Example 1 | 0.370 | −0.022 | −0.25 | 50 |
| Example 2 | 0.365 | −0.030 | −0.25 | 45 |
| Example 3 | 0.360 | −0.045 | −0.25 | 40 |

TABLE 9
Optical fiber parameters

| | | | | Cable | Mode | R = 15 mm, 10 turns | |
|---|---|---|---|---|---|---|---|
| | Attenuation (dB/km) | | | cutoff | field | Macro bending loss (dB) | |
| | 1310 | 1383 | 1550 | wavelength | diameter | 1550 nm < | 1625 nm < |
| Type | nm | nm | nm | (nm) | (μm) | 0.03 | 0.1 |
| Comparative Example | 0.337 | 0.287 | 0.187 | 1280 | 8.5 | 0.02 | 0.05 |
| Example 1 | 0.335 | 0.290 | 0.188 | 1222 | 8.9 | 0.02 | 0.07 |
| Example 2 | 0.334 | 0.285 | 0.186 | 1240 | 8.8 | 0.015 | 0.06 |
| Example 3 | 0.333 | 0.282 | 0.185 | 1230 | 8.7 | 0.01 | 0.04 |

It can be seen that for the bend-resistant optical fiber produced by the manufacturing process provided by examples of the present application, refractive index differences are formed between the core layer 100, the first cladding layer 200, the gradient layer 300 and the second cladding layer 400, thereby enabling the optical fiber to better confine a propagation path of light when bent, reducing light leakage and loss caused by the optical fiber bending, effectively controlling bending loss, and solving the problem of large bending loss of optical fibers in the prior art. Moreover, it can be seen from Table 9 that the bend-resistant optical fiber also has the advantages of a large mode field diameter, large effective area, excellent bending performance and compatibility with conventional optical fibers.

Finally, it should be noted that those skilled in the art will easily conceive other embodiments of the present disclosure after considering the specification and practicing the invention disclosed herein. The present disclosure is intended to cover any variations, uses or adaptive changes of the present disclosure, and these variations, uses or adaptive changes follow the general principles of the present disclosure and include common general knowledge or conventional technical means in the technical field not disclosed in the present disclosure. The present disclosure is not limited to the precise structures described above and shown in the accompanying drawings, and various modifications and changes can be made without departing from its scope. The scope of the present disclosure is only limited by the appended claims.

What is claimed is:

1. A bend-resistant optical fiber, comprising:
a core layer;
a first cladding layer wrapping the core layer;
a gradient layer wrapping the first cladding layer;
a second cladding layer wrapping the gradient layer;
wherein refractive indices of the core layer, the first cladding layer, the gradient layer and the second cladding layer decrease sequentially.

2. The bend-resistant optical fiber according to claim 1, wherein a refractive index n1 of the core layer is 0.35-0.42%;
and/or a refractive index n2 of the first cladding layer is −0.05% to 0;
and/or a refractive index n3 of the second cladding layer is −0.4 to −0.2%;
and/or a refractive index of the gradient layer exhibits a decreasing trend between n2 and n3.

3. A manufacturing process for the bend-resistant optical fiber according to claim 1, comprising the following steps:
sequentially depositing the core layer, the first cladding layer, the gradient layer and the second cladding layer to form a soot preform;
sintering the soot preform, and completing dehydration and fluorine doping such that the refractive indices of the core layer, the first cladding layer, the gradient layer and the second cladding layer decrease sequentially.

4. The manufacturing process according to claim 3, wherein a refractive index n1 of the core layer is 0.35-0.42%;
and/or a refractive index n2 of the first cladding layer is −0.05% to 0;
and/or a refractive index n3 of the second cladding layer is −0.4 to −0.2%;
and/or a refractive index of the gradient layer exhibits a decreasing trend between n2 and n3.

5. The manufacturing process according to claim 3, wherein sintering the soot preform and completing dehydration and fluorine doping comprises:
feeding the soot preform into sintering equipment; when a temperature of the soot preform is 1000-1100 °C, introducing chlorine gas at 0.5-1.0 slpm and helium gas at 10-50 slpm to carry out dehydroxylation for moisture removal;
when the temperature of the soot preform is 1000-1300 °C, introducing a fluoride at 0.3-2.0 slpm;
wherein a sintering speed of the soot preform is 6-15 mm/min.

6. The manufacturing process according to claim 4, wherein sintering the soot preform and completing dehydration and fluorine doping comprises:
feeding the soot preform into sintering equipment; when a temperature of the soot preform is 1000-1100 °C, introducing chlorine gas at 0.5-1.0 slpm and helium gas at 10-50 slpm to carry out dehydroxylation for moisture removal;
when the temperature of the soot preform is 1000-1300 °C, introducing a fluoride at 0.3-2.0 slpm;
wherein a sintering speed of the soot preform is 6-15 mm/min.

7. The manufacturing process according to claim 5, wherein feeding the soot preform into the sintering equipment comprises:
placing the soot preform into the sintering equipment provided with a gas inlet hole and a gas outlet hole;
controlling the temperature of the soot preform via a heating body inside the sintering equipment.

8. The manufacturing process according to claim 6, wherein feeding the soot preform into the sintering equipment comprises:
placing the soot preform into the sintering equipment provided with a gas inlet hole and a gas outlet hole;
controlling the temperature of the soot preform via a heating body inside the sintering equipment.

9. The manufacturing process according to claim 3, wherein sequentially depositing the core layer, the first cladding layer, the gradient layer and the second cladding layer to form the soot preform comprises:
in a cavity of deposition equipment, correspondingly depositing the core layer, the first cladding layer, the gradient layer and the second cladding layer by a core layer burner, a first cladding layer burner, a gradient layer burner and a second cladding layer burner respectively.

10. The manufacturing process according to claim 4, wherein sequentially depositing the core layer, the first cladding layer, the gradient layer and the second cladding layer to form the soot preform comprises:
in a cavity of deposition equipment, correspondingly depositing the core layer, the first cladding layer, the gradient layer and the second cladding layer by a core layer burner, a first cladding layer burner, a gradient layer burner and a second cladding layer burner respectively.

11. The manufacturing process according to claim 9, wherein the core layer burner and the second cladding layer burner are burners with an annular multi-layer cylindrical structure.

12. The manufacturing process according to claim 10, wherein the core layer burner and the second cladding layer burner are burners with an annular multi-layer cylindrical structure.

13. The manufacturing process according to claim 9, wherein the first cladding layer burner and the gradient layer burner are burners with a focusing structure.

14. The manufacturing process according to claim 10, wherein the first cladding layer burner and the gradient layer burner are burners with a focusing structure.

15. The manufacturing process according to claim 3, wherein after sintering the soot preform and completing dehydration and fluorine doping, the manufacturing process further comprises:
performing vitrification on the sintered soot preform to form a glass rod;
performing an elongation treatment on the glass rod to form a core rod;
depositing an outer cladding layer on an outer side of the core rod, and sintering this entire assembly to obtain an optical fiber preform;
performing a drawing treatment on the optical fiber preform.

16. The manufacturing process according to claim 4, wherein after sintering the soot preform and completing dehydration and fluorine doping, the manufacturing process further comprises:
performing vitrification on the sintered soot preform to form a glass rod;
performing an elongation treatment on the glass rod to form a core rod;
depositing an outer cladding layer on an outer side of the core rod, and sintering this entire assembly to obtain an optical fiber preform;
performing a drawing treatment on the optical fiber preform.

17. The manufacturing process according to claim 15, wherein performing vitrification on the sintered soot preform comprises:
when the temperature of the soot preform is 1300-1500 °C, introducing helium gas at 10-50 slpm to perform vitrification to form the glass rod.

18. The manufacturing process according to claim 16, wherein performing vitrification on the sintered soot preform comprises:
when the temperature of the soot preform is 1300-1500 °C, introducing helium gas at 10-50 slpm to perform vitrification to form the glass rod.
